(19) United States
(12) Patent Application Publication
(10) Pub. No.: US 2010/0062141 A1
(43) Pub. Date: Mar. 11, 2010

(54) STERILE SUCRALOSE SOLUTION WITHOUT PRESERVATIVES

(75) Inventor: Lassaad Boujbel, Nabeul (TN)

Correspondence Address: GREENBLUM & BERNSTEIN, P.L.C., 1950 ROLAND CLARKE PLACE, RESTON, VA, 20191, US

(73) Assignee: Lassaad BOUJBEL, Nabeul (TN)

(21) Appl. No.: 12/526,740

(22) PCT Filed: Mar. 30, 2007
(86) PCT No.: PCT/TN07/00002

§ 371 Date: Aug. 11, 2009

(30) Foreign Application Priority Data
Feb. 12, 2007 (TN) SN 07056

(51) Int. Cl. A23L 1/236; B65B 55/12

(52) U.S. Cl. 426/658; 426/506; 426/399; 426/394

(57) ABSTRACT

The invention relates to a novel composition of a nutritional complement and to the production method thereof. Said composition is a sucralose sweetening agent in a sterile solution without preservatives. Sucralose exists on the market mainly in a powder or tablet form and sometimes in a liquid form with preservatives. The novel composition and the aseptic production method thereof enable sucralose in a sterile solution to be obtained without adding preservatives.

The present invention relates to a novel composition of a nutritional complement and to the production method thereof. This is a sucralose sweetening agent in sterile solution without preservatives.

This sweetening agent is mainly used by people with diabetes or weight problems. It is also widely used in other fields and for other applications, such as in the food industry, intended for weight loss diet programs.

Diabetes is a disease caused by insufficient insulin secretion by the pancreas (so-called insulin-dependent or type 1 diabetes), or by insufficient cell receptivity to insulin, leading to diabetes mellitus characterized by hyperglycemia (so-called non-insulin-dependent or type 2 diabetes); this latter type of diabetes is also called fat diabetes, because the patients are generally obese, and concerns more than 90% of diabetics.

Obesity and overweight problems, especially pediatric obesity, are regarded as an increasingly alarming healthcare problem.

Although discoveries began in 1857 with saccharin, it was only in recent years that a sharp rise in awareness led to the development of an increasing number of commercially available sweetening products, with little or no caloric addition.

The most commonly used sweetening agents include saccharin, cyclamates and aspartame.

The use of saccharin and cyclamates is prohibited in certain countries because of a possible carcinogenic effect.

Aspartame is still considered to be safe, with the exception of minor undesirable effects, such as migraines, after an extended use. Aspartame also has low stability; it degrades under heat by generating toxic substances.

In view of these drawbacks, a new product, namely sucralose, was developed in 1976. This is a sweetener obtained from natural sugar or sucrose, having a sweetening power approximately 600 times higher than that of sugar. It was first approved for use in Canada in 1991. It was subsequently approved in Australia in 1993, in New Zealand in 1996, in the United States in 1998, in the European Union in 2004, and in Switzerland in 2006. It is currently approved for use in more than 23 countries.

Sucralose has several advantages over the other sweeteners. It is not carcinogenic; it is heat-stable (unlike aspartame); it is stable in solution over a broad range of pH conditions. Thus, it has a longer lifespan.

It can be used in food products to be cooked in oven or in food products having a long shelf life.

Furthermore, sucralose is non-carcinogenic and does not give rise to tooth decay.

The European Union has authorized the addition of sucralose in the following products (nonexhaustive list):
Nonalcoholic Beverages
Desserts and similar products
Confectioneries
Mustard

Sucralose is commercially available and comes mainly in powder or tablet form, and sometimes in liquid form with preservatives.

The solution form is more stable; however, the presence of preservatives in the liquid form has several drawbacks and presents risks of undesirable effects.

Therefore, there is a need to produce a liquid form that is more stable and easier to use, without the negative effects of the preservatives.

This is why the object of the present invention is a novel composition and the aseptic production method thereof, which enables sucralose in a sterile solution to be obtained without requiring the addition of preservatives.

The invention contains sucralose and water for injectable preparations manufactured under completely aseptic conditions yielding a sterile product that does not require adding preservatives. All of the manufacturing operations are carried out in compliance with Good Manufacturing Practices standards governing the obtaining of a sterile product.

The bulk weighing and preparation operations are carried out under Class C laminar flow. The bulk preparation consists of dissolving sucralose powder in water for injectable preparations, and shaking until complete dissolution and adjustment to the final volume in order to obtain a solution having a concentration between 0.1 mg/ml and 1 g/ml, depending upon the selection.

The solution obtained is then subject to an adequate sterilization according to one of the various methods for sterilizing a product.

Sterilization can be obtained in particular by sterilizing filtration using a 0.22 μm hydrophilic filter.

Subsequently, the sterile solution obtained is distributed aseptically in bottles under Class A laminar flow. Capping the bottles is also carried out under the same conditions.

The sterile sucralose solution invention is packaged in bottles of various capacities. These bottles can also be dropping bottles.

The present invention has several advantages:
Convenience of use: very rapid solubility in beverages, coffee, tea and cakes.
Convenience of use and of homogenization in pasty and semi-solid forms.
For the dropping bottle, convenience of use of the bottle of sucralose: small volume, practical and clean use.
Greater stability of this solution form,
Resistance to cooking heat: sucralose is a heat-resisting molecule.
Absence of preservatives.

1-11. (canceled)

12. Composition of sucralose in sterile solution.

13. Composition according to claim 12 containing no preservatives.

14. Composition according to claim 12, characterized in that it contains sucralose and water for injectable preparations manufactured under completely aseptic conditions without requiring the addition of preservatives.

15. Composition according to claim 12, characterized in that it has been subject to sterilization.

16. Method for obtaining sucralose in sterile solution containing sucralose and water for injectable preparations manufactured under completely aseptic conditions, yielding a product that does not require adding preservatives.

17. Method according to claim 16 including:
(a) a bulk preparation step including the dissolution of sucralose powder in water for injectable preparations;
(b) a shaking step until complete dissolution of the sucralose powder in the water; and
(c) a step of sterilizing the solution obtained.

18. Method according to claim 17, characterized in that the bulk preparation operations are carried out under Class C laminar flow.

19. Method according to claim 17, characterized in that the concentration of the solution obtained in step (b) is between 0.1 mg/ml and 1 g/ml.

20. Method according to claim 17, characterized in that the sterilization is obtained by sterilizing filtration.

21. Method according to claim 20, characterized in that the sterilizing filtration is carried out using a 0.22μ hydrophilic filter.

22. Method according to claim 17, including a step (d) for distributing the sterile solution from step (c) in bottles under Class A laminar flow.

23. Method according to claim 22, characterized in that the bottles are dropping bottles.
